(19) United States
(12) Patent Application Publication
(10) Pub. No.: US 2021/0158153 A1
(43) Pub. Date: May 27, 2021

(54) METHOD AND SYSTEM FOR PROCESSING FMCW RADAR SIGNAL USING LIGHTWEIGHT DEEP LEARNING NETWORK

(71) Applicant: Korea Electronics Technology Institute, Seongnam-si (KR)

(72) Inventors: Young Han LEE, Yongin-si (KR); Sung Ho LEE, Seoul (KR); Min Geon SHIN, Seongnam-si (KR)

(21) Appl. No.: 16/952,481

(22) Filed: Nov. 19, 2020

(30) Foreign Application Priority Data
Nov. 21, 2019 (KR) 10-2019-0150532

(51) Int. Cl. G06N 3/08; G01S 13/34; G01S 7/35

(52) U.S. Cl. CPC G06N 3/08; G01S 2007/356; G01S 7/352; G01S 13/34

(57) ABSTRACT

A method and a system for processing an FMCW radar signal by using a lightweight deep learning network are provided. The data processing method using an AI model includes: converting n-dimensional data into a plurality of pieces of 2D data; inputting the plurality of pieces of 2D data into the AI model through different channels; and processing the plurality of pieces of 2D data inputted to the AI model by analyzing. Accordingly, an amount of computation and a memory usage can be reduced and characteristics of an object can be learned and inferred by the lightweight deep learning network.

### CROSS-REFERENCE TO RELATED APPLICATION(S) AND CLAIM OF PRIORITY

This application is based on and claims priority under 35 U.S.C. § 119 to Korean Patent Application No. 10-2019-0150532, filed on Nov. 21, 2019, in the Korean Intellectual Property Office, the disclosure of which is herein incorporated by reference in its entirety.

### BACKGROUND

### Field

The present disclosure relates generally to artificial intelligence (AI) technology, and more particularly, to a method for inferring characteristics (a movement, a state, etc.) of a target object by analyzing frequency modulated continuous wave (FMCW) radar signal processing by an AI model.

### Description of Related Art

Since FMCW radar signal-based information processing techniques have the advantage of implementing an input device with a small form factor, at a low cost, relevant researches are proceeding actively, and analysis by utilizing an AI model is being attempted.

However, since radar signals processed are expressed by 3-dimensional (3D) data, machine learning using radar signals, such as a deep learning network, may require large amounts of computation and a high memory usage.

To this end, the size of a machine learning module may increase in comparison to an input device of a small form factor, and accordingly, problems may be solved by using low-level machine learning techniques, rather than using high-level techniques such as a deep learning network.

However, this solution has a problem of degraded performance Therefore, there is a demand for a method for using a deep learning network, while guaranteeing the merits of easiness of future relearning, robust performance, etc.

### SUMMARY

To address the above-discussed deficiencies of the prior art, it is a primary object of the present disclosure to provide a method for inferring characteristics of an object by converting 3D data of distance, velocity, time obtained through FMCW radar signal processing into 2D data, and inputting the 2D data into a lightweight deep learning network.

According to an embodiment of the present disclosure to achieve the above-described object, a data processing method using an AI model includes: converting n-dimensional data into a plurality of pieces of 2D data; inputting the plurality of pieces of 2D data into the AI model through different channels; and processing the plurality of pieces of 2D data inputted to the AI model by analyzing.

The converting may include converting the n-dimensional data into n−1 pieces of 2D data.

According to an embodiment, the method may further include generating the n-dimensional data by performing FFT with respect to an FMCW radar signal, and the converting may include converting the generated n-dimensional data into n−1 pieces of 2D data.

n may be 3, a first axis of the 3-dimensional data may indicate velocity data, a second axis of the 3-dimensional data may indicate range data, and a third axis of the 3-dimensional data may indicate time data.

In addition, one piece of 2D data may have a first axis representing a velocity and a second axis presenting time, and another piece of 2D data may have a first axis representing a range and a second axis representing time.

The method may further include classifying the plurality of pieces of 2D data and setting an ROI with respect to each piece of 2D data, and the inputting may include inputting the plurality of pieces of 2D data in which the ROIs are set into the AI model.

The AI model may include a 2D convolutional layer for processing 2D data.

In addition, the processing may include: training the AI model with the plurality of pieces of 2D data inputted; and inferring a result from the plurality of pieces of 2D data inputted to the AI model.

In addition, the inferring may include inferring at least one of a state, a movement, a behavior, and a gesture of an object.

According to another embodiment of the present disclosure, a data processing system using an AI model includes: a signal processor configured to convert n-dimensional data into a plurality of pieces of 2D data; and a processor configured to input the plurality of pieces of 2D data into the AI model through different channels, and to process the plurality of pieces of 2D data inputted to the AI model by analyzing.

According to another embodiment of the present disclosure, a data processing method using an AI model includes: inputting a plurality of pieces of 2D data converted from n-dimensional data into the AI model; and processing the plurality of pieces of 2D data inputted to the AI model by analyzing.

According to another embodiment of the present disclosure, a data processing system using an AI model includes: a processor configured to input a plurality of pieces of 2D data converted from n-dimensional data into the AI model, and to process the plurality of pieces of 2D data inputted to the AI model by analyzing, and a storage configured to provide a storage space necessary for the processor.

According to embodiments of the present disclosure described above, by converting 3D data of distance, velocity, time obtained through FMCW radar signal processing into 2D data, and inputting the 2D data into the lightweight deep learning network, an amount of computation and a memory usage can be reduced, and characteristics of an object can be learned and inferred by the lightweight deep learning network.

In addition, according to embodiments of the present disclosure, ROIs are independently and differently set according to 2D data, so that an amount of computation required by the deep learning network can further be reduced.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart provided to explain a method for processing an FMCW radar signal of a deep learning network according to an embodiment of the present disclosure;

FIG. 2 is a view illustrating 3D radar data;

FIG. 3 is a view illustrating 3D convolutional layers;

FIG. 4 is a view illustrating 2D convolutional layers;

FIG. 5 is a view provided to explain a method of converting 3D radar data into 2D radar data;

FIG. 6 is a view provided to explain a method of converting 3D radar data into 2D radar data;

FIG. 7 is a view illustrating a result of converting 3D radar data into two pieces of 2D data;

FIG. 8 is a view provided to explain a method of setting a region of interest (ROI) in two pieces of 2D data according to a channel;

FIG. 9 is a block diagram of a radar system according to another embodiment of the present disclosure;

FIG. 10 is a flowchart provided to explain a method for processing an FMCW radar signal of a deep learning network according to another embodiment of the present disclosure; and

FIGS. 11 and 12 are views provided to additionally explain the FMCW radar signal processing method shown in FIG. 10.

### DETAILED DESCRIPTION

Hereinafter, the present disclosure will be described in detail with reference to the accompanying drawings.

In an embodiment of the present disclosure, a lightweight deep learning network is trained to infer a movement of a target object from an FMCW radar signal, and, by using the lightweight deep learning network, a movement of a target object is inferred from an FMCW radar signal input.

Based on the inferred movement of the target object, subsequent processing such as user experience (UX)/user interface (UI) processing, device/system control, etc. may be performed.

Considering that the lightweight deep learning network is used, in an embodiment of the present disclosure, an FMCW radar signal processed in three dimensions is converted into two pieces of 2D data and the two pieces of 2D data are inputted to the deep learning network through individual channels.

Furthermore, by independently designing an ROI for each channel, characteristics of each channel are reflected, and simultaneously, an amount of computation of the deep learning network can be reduced.

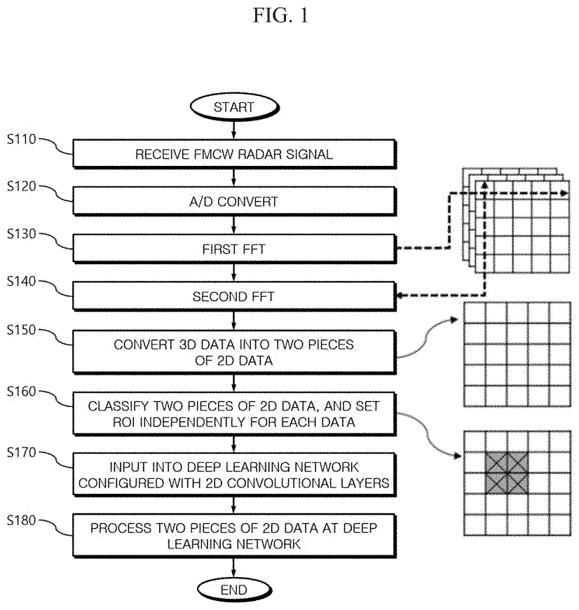

FIG. 1 is a flowchart provided to explain an FMCW radar signal processing method of a deep learning network according to an embodiment of the present disclosure.

As shown in FIG. 1, an FMCW radar signal is received (S110) and is converted into a digital signal (S120), and then, 3D radar data is generated by performing fast Fourier transform (FFT) two times (S130, S140).

The FMCW radar refers to a technique for understanding characteristics (for example, a distance, a movement, etc.) of an object by calculating differences in time and phase between a radar signal transmitted and a radar signal received after being transmitted and reflected.

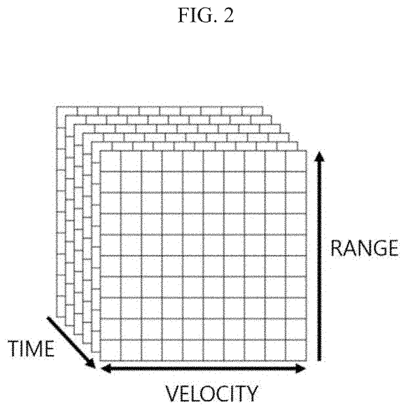

The 3D radar data generated at steps S130 and S140 is illustrated in FIG. 2. As shown in FIG. 2, the 3D radar data is configured with velocity data (Doppler), range data (Range), and time data (Time) expressed on respective axes.

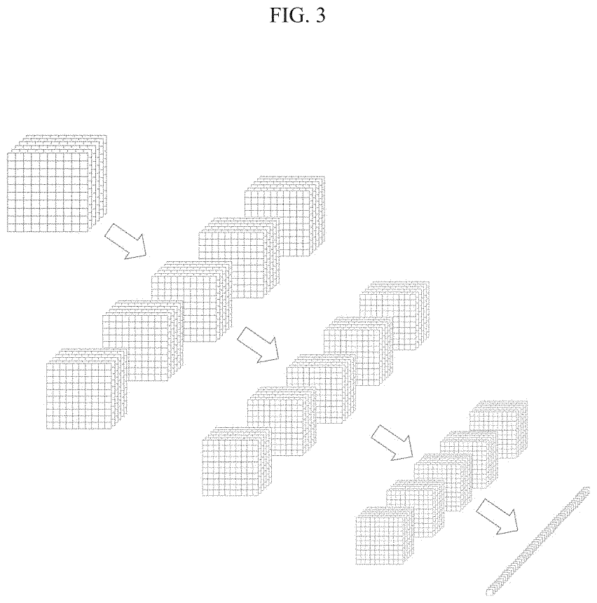

In order to learn and infer a movement of a target object by processing such 3D data, a deep learning model should be configured with 3D convolutional layers as shown in FIG. 3.

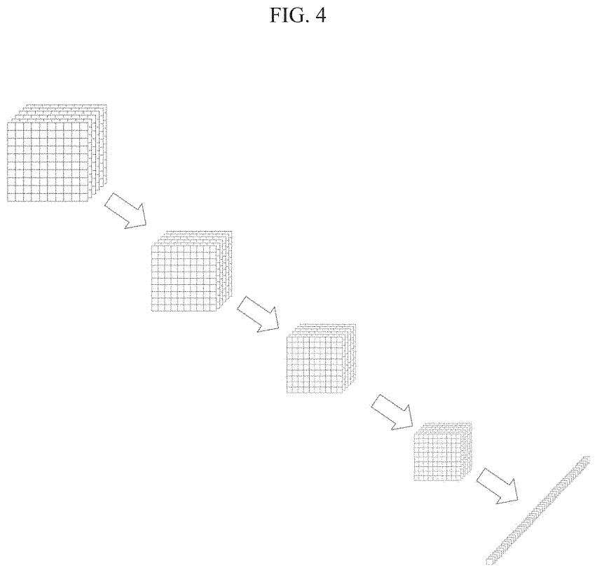

However, the 3D convolutional layer may increase an amount of computation as much as a square of a kernel size (N) and may increase a memory usage by N times, compared to a 2D convolutional layer shown in FIG. 4. The use of computation resources in this level may not be appropriate for a lightweight deep learning network.

Accordingly, in an embodiment of the present disclosure, a procedure of converting 3D data into two pieces of 2D data is performed (S150). That is, 3D data is converted into data suitable for the lightweight deep learning network.

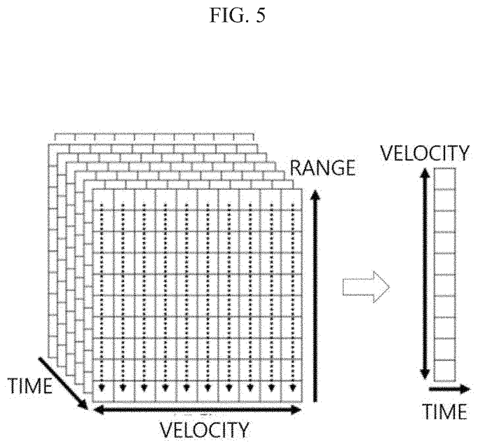

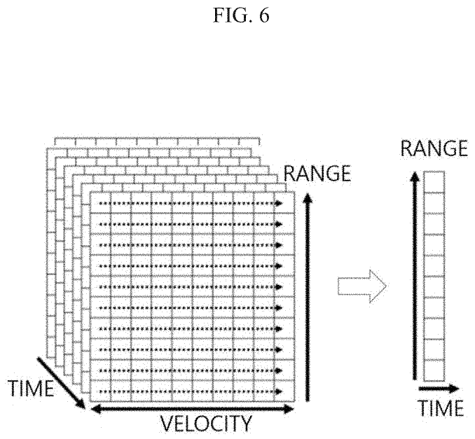

Specifically, at step S150, the 3D radar data is converted into 2D data (Doppler, Time) that is configured with one axis representing a velocity and the other axis representing time, and into 2D data (Range, Time) that is configured with one axis representing a range and the other axis representing time, as shown in FIGS. 5 and 6.

This conversion may be expressed by the following equations:

3D data, RVT(r,v,t)

First 2D data RT(r,t)=ΣᵥRVT(r,v,t)

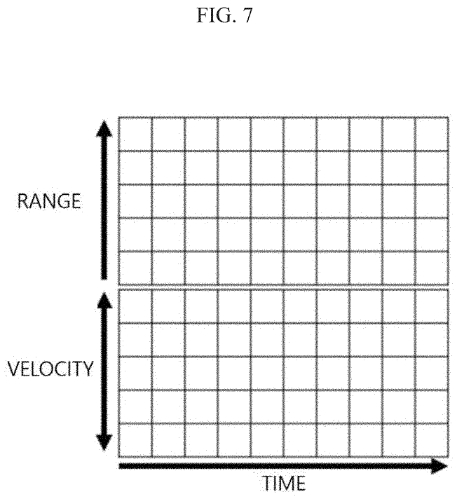

Second 2D data RV(v,t)=Σᵣ RVT(r,v,t)

where R(r) is range data, V(v) is velocity data, and T(t) is time data. FIG. 7 illustrates a result of converting 3D radar data into two pieces of 2D data.

Next, the two pieces of 2D data generated at step S150 are distinguished, and an ROI is set independently and individually with respect to each of the two pieces of 2D data (S160).

The two pieces of 2D radar data which are obtained by dimensionality reduction conversion generally contain characteristics of the target object to be classified, but the characteristics are not expressed across the entire area and appear in an area spatially limited.

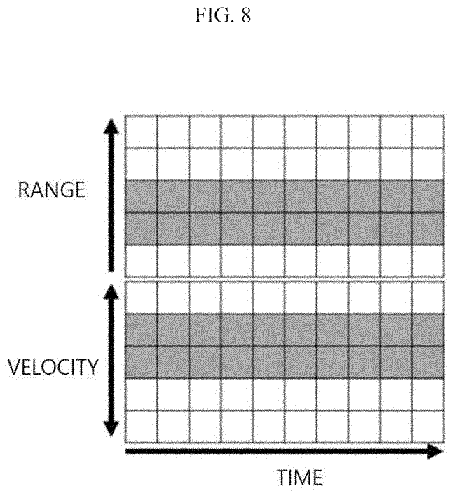

Accordingly, setting and using the ROI as shown in FIG. 8 is more effective from an aspect of an amount of computation than using radar data of all areas as an input. This is because the amount of computation in the deep learning network is proportional to a size of input data.

Since the radar signal is independent from a channel like an image signal, but the radar signal has different spatial characteristics according to each channel unlike the image signal, an ROI may be set differently according to each channel.

ROIs of different ranges are set for the two pieces of 2D data to be used as an input of the deep learning network, but the channels are configured to have ROI results of the same size.

The two pieces of 2D data having the ROIs set therein at step S160 are inputted to the deep learning network which is configured with 2D convolutional layers through different channels (S170), and the two pieces of 2D data are processed at the deep learning network (S180).

When a learning process is performed, movement information of the target object is further given to an output terminal of the deep learning network at step S170, and the deep learning network is trained at step S180.

When an inference process is performed, the deep learning network classifies (infers) the movement of the target object by analyzing the inputted two pieces of 2D data at step S180.

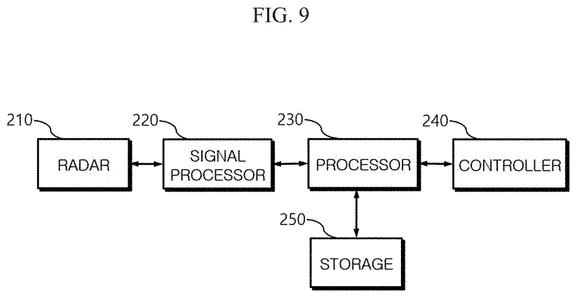

FIG. 9 is a block diagram of a radar system according to another embodiment of the present disclosure. As shown in FIG. 9, the radar system according to the embodiment may include a radar 210, a signal processor 220, a processor 230, a controller 240, and a storage 250.

The radar 210 transmits an FMCW radar signal and receives a radar signal reflected from an object.

The signal processor 220 converts the received radar signal into a digital signal, and then, generates 3D radar data by performing FFT two times. The signal processor 220 converts the 3D data into two pieces of 2D data, and distinguishes between the two pieces of 2D data, and detects/sets ROIs independently and individually with respect to each of the two pieces of 2D data.

The processor 230 is a set of graphic processing units (GPUs) and central processing units (CPU) for executing the above-described lightweight deep learning network.

The deep learning network executed by the processor 230 is configured with 2D convolutional layers, and receives the two pieces of 2D data in which ROIs are individually set through different channels, and processes (learns, classifies/infers) the two pieces of 2D data.

The controller 240 perform subsequent processing, such as UI/UX processing, device/system control, etc., according to a result of inferring by the deep learning network.

The storage 250 provides a storage space necessary for functions and operations of the processor 230.

Up to now, the method of training the lightweight deep learning network to infer a movement of a target object from an FMCW radar signal, and inferring the movement of the target object from an FMCW radar signal input by using the deep learning network has been described in detail with reference to preferred embodiments.

In the above-described embodiments, it is assumed that 3D radar data is converted into two pieces of 2D data, and the two pieces of 2D data are inputted to the deep learning network through individual channels. However, the embodiment can be extended.

For example, 4D data having velocity data, range data, angle data, and time data expressed on their respective axes may be converted into three pieces of 2D data. In this case, the three pieces of 2D data may include 1) 2D data having one axis representing a velocity and the other axis representing time, 2) 2D data having one axis representing a range and the other axis representing time, and 3) 2D data having one axis representing angle and the other axis representing time.

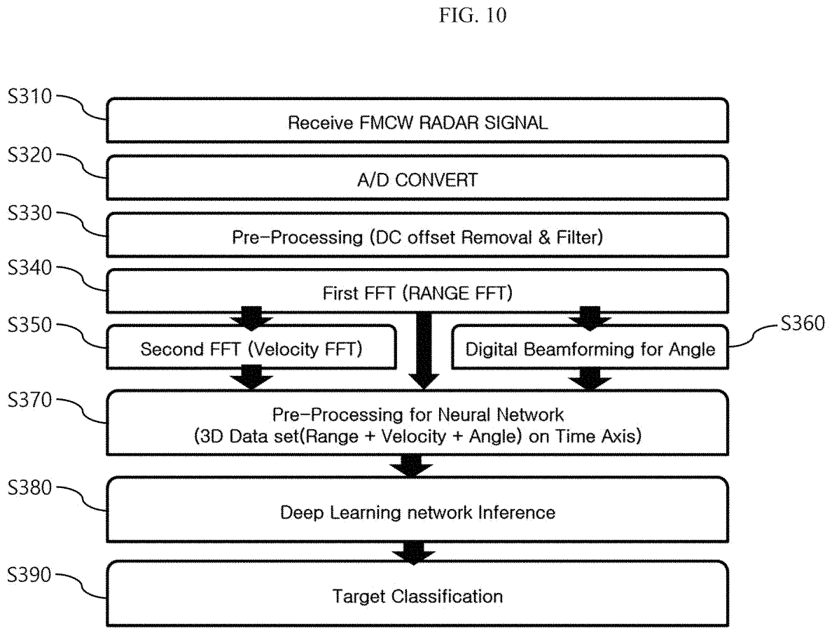

FIG. 10 is a flowchart provided to explain a method for processing an FMCW radar signal of a deep learning network according to another embodiment of the present disclosure.

As shown in FIG. 10, an FMCW radar signal is received (S310) and is converted into a digital signal (S320), and then, DC offset removal and filtering are performed as pre-processing (S330). Next, 4D radar data is generated by performing FFT two times and performing digital beamforming for an angle (S340, S350, S360).

A procedure of converting 4D data into three pieces of 2D data is performed (S370). That is, 4D data is converted into data suitable for the lightweight deep learning network.

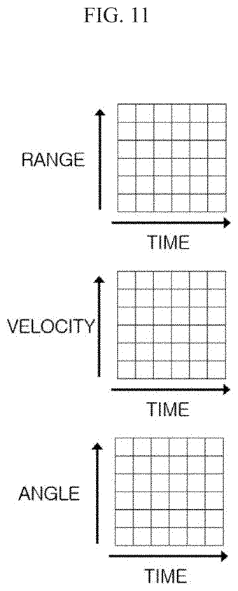

Specifically, at step S370, the 4D radar data is converted into 2D data that is configured with one axis representing time and the other axis representing range, velocity, and angle as shown in FIG. 11.

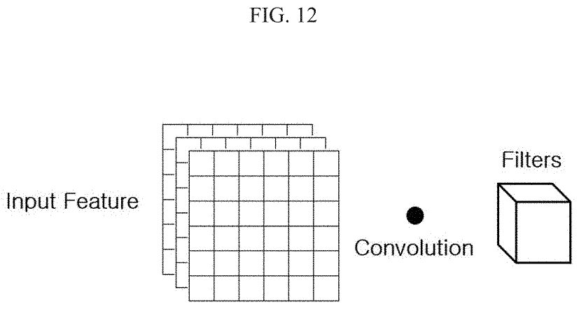

The three pieces of 2D data generated at step S370 are inputted to the deep learning network which is configured with 2D convolutional layers through different channels (S380), and the three pieces of 2D data are processed at the deep learning network (S390). These operations are illustrated in FIG. 12.

When a learning process is performed, movement information of a target object is further given to an output terminal of the deep learning network at step S380, and the deep learning network is trained at step S390.

When an inference process is performed, the deep learning network classifies (infers) the movement of the target object by analyzing the inputted three pieces of 2D data at step S390.

Furthermore, the technical concept of the present disclosure may be extended to the case where n-dimensional data is converted into n−1 pieces of 2 D data.

In addition, in the above-described embodiments, it is assumed that a movement of a target object is inferred from radar data, but the technical concept of the present disclosure can be applied to the case where other characteristics, for example, a state, a behavior, a gesture, are inferred in addition to the movement.

In addition, the above-described data processing using the lightweight deep learning network can be implemented for other types of data, instead of radar data.

In addition, the above-mentioned deep learning network is merely an example of an AI model, and may be substituted with other types of AI models.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

What is claimed is:

1. A data processing method using an AI model, the method comprising:
converting n-dimensional data into a plurality of pieces of 2D data;
inputting the plurality of pieces of 2D data into the AI model through different channels; and
processing the plurality of pieces of 2D data inputted to the AI model by analyzing.

2. The method of claim 1, wherein the converting comprises converting the n-dimensional data into n−1 pieces of 2D data.

3. The method of claim 2, further comprising generating the n-dimensional data by performing FFT with respect to an FMCW radar signal,
wherein the converting comprises converting the generated n-dimensional data into n−1 pieces of 2D data.

4. The method of claim 3, wherein n is 4,
wherein a first axis of the 4-dimensional data indicates velocity data,
wherein a second axis of the 4-dimensional data indicates range data,
wherein a third axis of the 4-dimensional data indicates angle data, and
wherein the forth axis of the 4-dimensional data indicates time data.

5. The method of claim 4, wherein one piece of 2D data has a first axis representing a velocity and a second axis presenting time,
wherein another piece of 2D data has a first axis representing a range and a second axis representing time, and
wherein still another piece of 2D data has a first axis representing an angle and a second axis presenting time.

6. The method of claim 1, further comprising classifying the plurality of pieces of 2D data and setting an ROI with respect to each piece of 2D data,
wherein the inputting comprises inputting the plurality of pieces of 2D data in which the ROIs are set into the AI model.

7. The method of claim 1, wherein the AI model comprises a 2D convolutional layer for processing 2D data.

8. The method of claim 1, wherein the processing comprises:
training the AI model with the plurality of pieces of 2D data inputted; and
inferring a result from the plurality of pieces of 2D data inputted to the AI model.

9. The method of claim 8, wherein the inferring comprises inferring at least one of a state, a movement, a behavior, and a gesture of an object.

10. A data processing system using an AI model, comprising:
a signal processor configured to convert n-dimensional data into a plurality of pieces of 2D data; and
a processor configured to input the plurality of pieces of 2D data into the AI model through different channels, and to process the plurality of pieces of 2D data inputted to the AI model by analyzing.

11. A data processing method using an AI model, the method comprising:
inputting a plurality of pieces of 2D data converted from n-dimensional data into the AI model; and
processing the plurality of pieces of 2D data inputted to the AI model by analyzing.
